(19) United States
(12) Patent Application Publication
(10) Pub. No.: US 2025/0197545 A1
(43) Pub. Date: Jun. 19, 2025

(54) (METH)ACRYLIC COMPOSITION, POLYMERIC COMPOSITE MATERIAL OBTAINED FROM SUCH A COMPOSITION, METHOD FOR PRODUCING SAID COMPOSITION AND MATERIAL, AND USES THEREOF

(71) Applicant: Arkema France, Colombes (FR)

(72) Inventors: Gilles FRANCOIS, Pierre-Benite Cedex (FR); Matthieu BEHR, Saint Avold Cedex (FR)

(73) Assignee: Arkema France, Colombes (FR)

(21) Appl. No.: 18/836,528

(22) PCT Filed: Feb. 7, 2023
(86) PCT No.: PCT/EP2023/053015

§ 371 Date: Aug. 7, 2024

(30) Foreign Application Priority Data
Feb. 8, 2022 (FR) FR2201063

(51) Int. Cl. C08F 265/06; C08J 3/20; C08K 3/013; C08K 5/14; C08K 5/3435; C08K 5/375; C08K 5/5425

(52) U.S. Cl. CPC C08F 265/06; C08J 3/203; C08K 3/013; C08K 5/14; C08K 5/3435; C08K 5/375; C08K 5/5425; C08J 2351/06

(57) ABSTRACT

The present invention relates to a (meth)acrylic composition suitable for (meth)acrylic polymeric compositions and composites, its method of preparation and its use. In particular the present invention relates to a (meth)acrylic composition that possesses once polymerized a certain heat resistance and that is suitable for (meth)acrylic composites used at higher temperatures. More particularly the present invention relates to a (meth)acrylic composition suitable for preparing (meth)acrylic polymeric compositions and composite materials. The present invention also relates also to a method for the preparation of such a (meth)acrylic composition and its use, but also (meth)acrylic polymeric compositions and composite materials prepared from such a (meth)acrylic composition. Additionally the invention also relates to a manufacturing process and to the uses of such a composite material that may be applied in many industrial sectors.

### CROSS-REFERENCE TO RELATED APPLICATIONS

This application is the United States National Stage under 35 U.S.C. § 371 of PCT International Patent Application No. PCT/EP2023/053015, filed on Feb. 7, 2023, and claiming priority to French Patent Application No. FR2201063, filed on Feb. 8, 2022.

### FIELD OF THE INVENTION

The present invention The relates to a (meth)acrylic composition suitable for (meth)acrylic polymeric compositions and composites, its method of preparation and its use.

In particular the present invention relates to a (meth)acrylic composition that possesses once polymerized a certain heat resistance and that is suitable for (meth)acrylic composites used at higher temperatures.

More particularly the present invention relates to a (meth)acrylic composition suitable for preparing (meth)acrylic polymeric compositions and composite materials.

The present invention also relates also to a method for the preparation of such a (meth)acrylic composition and its use, but also (meth)acrylic polymeric compositions and composite materials prepared from such a (meth)acrylic composition.

Additionally also relates to a the invention manufacturing process and to the uses of such a composite material that may be applied in many industrial sectors.

### Technical Problem

Compositions comprising (meth)acrylic polymers are widely used. This is mainly due to the characteristic that these polymers are highly transparent polymer materials with excellent resistance to ultraviolet radiation and weathering. However (meth)acrylic polymers are also used in applications where the transparency is not necessarily required, as for example in polymeric composites.

A composite material is a macroscopic combination of two or more non miscible materials. The composite material constitutes at least of a matrix material that forms a continuous phase for the cohesion of the structure and a reinforcing material with various architectures for the mechanical properties.

The aim in using composite materials is to achieve a performance from the composite material that is not available from its separate constituents if used alone. Consequently, composite materials are widely used in several industrial sectors as for example building, automotive, aerospace, transport, leisure, electronics, and sport notably due to their better mechanical performance (higher tensile strength, higher tensile modulus, higher fracture toughness) in comparison with homogenous materials and their low density.

One of the most important class in view of volume in commercial industrial scale, are composites with organic matrices, where the matrix material is a generally polymer. The principal matrix or continuous phase of a polymeric composite material is either a thermoplastic polymer or a thermosetting polymer.

Thermosetting polymers consist of crosslinked three-dimensional structures. The crosslinking is obtained by curing reactive groups inside the so-called prepolymer. Curing for example can be obtained by heating the polymer chains in order to crosslink and harden the material permanently. In order to prepare the polymeric composite material the prepolymer is mixed with the other component (for example glass beads for a particulate composite or short fibers for a fibrous composite) or the other component is wetted or impregnated (for example woven nets) and cured afterwards

Examples for prepolymers or matrix material for thermoset polymers are unsatured polyesters, vinylesters, epoxy or phenolic ones. This manufacturing of the semi-fabricated products yields to the so called prepregs

A disadvantage of a thermoset polymer matrix is its very high crosslinkage. The matrix cannot be easily shaped in other forms. Once the polymer has been cured the form is fixed. Also recycling of thermoset polymers or composites based on thermoset polymers is difficult or impossible. Another issue is the environmental or health impact of raw materials for thermoset polymers.

Thermoplastic polymers consist of or compromise linear or branched or slightly crosslinked polymer chaines. The thermoplastic polymers can be heated in order to mix the two constituents necessary for producing the composite material and to be cooled for setting. One limit in using these thermoplastic polymers for the fabrication of composite materials is their high viscosity in the molten state. The wetting or correct impregnation of the fibers by the thermoplastic polymer can only be achieved, if the thermoplastic resin is sufficiently fluid. In order to have a low viscosity or sufficient fluidity of the thermoplastic polymer the chain length (molecular mass) can be reduced. However, a too low molecular weight has a negative impact on the performance of the composite material especially the mechanical properties. On the other hand the temperature of the thermoplastic polymer could be increased in order to reduce the viscosity in an important way. Consequently, the continuous working temperature is relatively high, above 200° C., influencing directly the economics (costs) of the composite material due to implication of high energy costs.

Additionally thermoplastic polymers tend to degrade if the temperature is very high, which is especially true for semicrystalline thermoplastic polymers that have high melting points as for example polyamides (for example PA6.6), polyethersulfon (PES), polyetherimid (PEI), polyetheretherketon (PEEK) or polyphenylene sulfide (PPS). This thermo induced degradation yields to a decreasing molecular weight of the polymer matrix which is important for the cohesion of the composite material.

Another way for impregnating the fibrous substrate is to dissolve the thermoplastic polymer in an organic solvent. However this method requires a lot of solvent that has to be evaporated. There are environmental issues in using large quantities of solvent in term of energy and pollution.

Still another way for preparing a polymeric composite material based on thermoplastic polymers is a thermoplastic polymer resin comprising a monomer, commonly known as a “syrup”. The syrup is used to blend with or impregnate the reinforcing material, for example a filler or a fibrous substrate. Once polymerized, meaning that the monomer has been polymerized, the thermoplastic polymeric resin constitutes the matrix of the composite material. At the time of blending or impregnation, when preparing polymeric composites, the viscosity of the impregnation syrup must be controlled and adapted so as not to be too fluid or too viscous, so as to achieve a homogenous blend with filler or impregnate correctly each fibre of the fibrous substrate. When the wetting is partial, depending on whether the syrup is too fluid or too viscous, “naked” zones, i.e. non-impregnated zones, and zones in which drops of polymer form on the fibres, which are the cause of the creation of bubbles, respectively appear. These “naked” zones and these bubbles give rise to the appearance of defects in the final composite material, which are the cause, inter alia, of a loss of mechanical strength of the final composite material. However the viscosity range useful for the impregnation is low for stocking such material.

A disadvantage for the preparation of thermoplastic composite with respective reinforcements from a syrup is the degradation of the polymer when the composite is used at higher temperature.

There is a need of a polymeric composition that provides a high thermal resistance and aging resistance at higher temperatures.

There is also a need of a polymeric composition that provides a high thermal resistance and aging resistance at higher temperatures as continuous phase in polymeric composites.

There is also the need to replace thermoset polymers in composites by polymers that are more easily recyclable and use raw materials that have less environmental and/or health issues.

There is also the need to have a satisfying pot life of the composition before polymerization that yield to said polymeric composition. The composition should be stable for handling when preparing the blend with filler or performing impregnation of fibre or the fibrous substrate.

The objective of the present invention is to have a composition for preparing a (meth)acrylic polymeric compositions with a high thermal resistance and aging resistance at increased temperatures.

The objective of the present invention is also to have a composition for preparing a (meth)acrylic composite composition with a high thermal resistance and aging resistance at increased temperatures.

The objective of the present invention is also to provide a (meth)acrylic composition for preparing (meth)acrylic polymeric compositions or (meth)acrylic composites composition, said meth)acrylic composition should have a sufficient pot life.

High thermal resistance present invention signifies a weight loss of the polymerized composition or composite composition at a temperature of above 150° C. or even 160° C. The weight loss shall be reduced over a period of for example 2000 hours of exposure to high temperature and preferably, the weight loss of the polymeric part at a temperature of 150° C. shall be less than 10% over a period of 2000 hours, more preferably at a temperature of 170° C. shall be less than 10% over a period of 5000 hours and even more preferably at a temperature of 170° C. shall be less than 5% over a period of 5000 hours.

Sufficient pot life in the present invention signifies that the (meth)acrylic composition can be handled and stocked at 20° C. for at least 12 hours preferably at least 24 hours without polymerization.

Another objective of the present invention is to provide a process for preparing a (meth)acrylic composition having a sufficient pot life useful for preparing a (meth)acrylic composite composition with a high thermal resistance.

Still another objective of the present invention is to have a method for preparing a (meth)acrylic composite composition with a high thermal resistance which also can be recycled.

### [BACKGROUND OF THE INVENTION] PRIOR ART

The document WO2013/056845 discloses a composite material via in-situ polymerization of thermoplastic (meth)acrylic resins. The polymeric composite material obtained by in-situ polymerization of a thermoplastic (meth)acrylic resin and a fibrous material containing long fibers and its use, a process for making such a composite material and mmanufactured mechanical or structured part or article comprising this polymeric composite material. The polymerization uses a radical initiator chosen from diacyl peroxides, peroxy esters, dialkyl peroxides, peroxyacetals or azo compounds. The document does not disclose anything about the obtained polymeric composite composition and its aging resistance especially at elevated temperatures.

The document WO2014/013028 an impregnation process for a fibrous substrate, a liquid (meth)acrylic syrup for the impregnation process, its method of polymerization and structured article obtained thereof. The liquid (meth)acrylic syrup comprises a (meth)acrylic polymer, a (meth)acrylic monomer and at least one initiator or initiating system for starting the polymerization of the (meth)acrylic monomer. The initiators or initiating systems that are activated by heat. The document does not disclose anything about the polymeric composite composition and its aging resistance especially at elevated temperatures.

The document WO2020/002842 discloses a (meth)acrylic composition comprising 100 parts by weight of a liquid (meth)acrylic syrup, 20 parts by weight to 300 parts by weight of a mineral filler C, 0.01 part by weight to 5 parts by weight of a (meth)acrylic monomer M2, the monomer M2 comprising at least two (meth)acrylic functions per monomer, 0.01 part by weight to 5 parts by weight of a (meth)acrylic monomer M3 and 0.01 part by weight to 5 parts by weight of a polymerization initiator.

The document WO2020/078991 discloses a (meth)acrylic composition MC1 comprising 100 parts of a liquid (meth)acrylic syrup, between 0.01 and 10 phr by weight of a (meth)acrylic monomer (M2) comprising at least two (meth)acrylic functions, from 0 to 10 phr by weight of a (meth)acrylic monomer (M3) comprising only one (meth)acrylic function said (meth)acrylic monomer (M3) is different from (meth)acrylic monomer (M1) and other optional compounds.

The document WO2020/079015 discloses a (meth)acrylic polymeric composition for composite, its method of preparation and use. The composition comprises 100 parts of a liquid (meth)acrylic syrup and between 0.01 and 10 phr by weight of a (meth)acrylic monomer (M2) comprising at least two (meth)acrylic functions.

All the prior art documents do not disclose a (meth)acrylic composition suitable for (meth)acrylic polymeric compositions or composites that have improved heat aging properties and pot life at the same time.

### BRIEF DESCRIPTION OF THE INVENTION

Surprisingly it has also been found that a (meth)acrylic composition MC1 comprising:
a) 100 parts of a liquid (meth)acrylic syrup comprising a1) between 10 wt % and 50 wt % of a (meth)acrylic polymer (P1),
a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) between 0.1 and 10 phr by weight of a (meth)acrylic monomer (M3) comprising only one (meth)acrylic function and the (meth)acrylic monomer (M3) is different from (meth)acrylic monomer (M1) said (meth)acrylic monomer (M3) if polymerized as a homopolymer has a glass transition temperature Tg of at least 110° C.;
   allows to provide a composition for the preparation of (meth)acrylic polymers or composites that possess a better heat aging resistance than a composition or composite not comprising the components b) and c).

Surprisingly it has also been discovered that a (meth)acrylic composition MC1 comprising:
a) 100 parts of a liquid (meth)acrylic syrup comprising a1) between 10 wt % and 50 wt % of a (meth)acrylic polymer (P1),
a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) between 0.1 to 10 phr by weight of a (meth)acrylic monomer (M3) comprising only one (meth)acrylic function and the (meth)acrylic monomer (M3) is different from (meth)acrylic monomer (M1);
   can be used to increase the heat aging resistance of a polymer or polymeric composite material made from that composition as compared to a composition not comprising the components b) and c).

Surprisingly it has also been discovered that method for preparing a (meth)acrylic polymeric compositions or for preparing a (meth)acrylic composite composition, said method comprises the steps of:
i) providing a (meth)acrylic composition MC1 comprising:
   a) 100 parts of a liquid (meth)acrylic syrup comprising a1) between 10 wt % and 50 wt % of a (meth)acrylic polymer (P1),
   a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) from 0.1 to 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.
ii) polymerizing said (meth)acrylic composition MC1 yields to a composition of (meth)acrylic polymers or composites that possess a better heat aging resistance as compared to a composition or composite not comprising the components b) and c).

### DETAILED DESCRIPTION OF THE INVENTION

According to a first aspect, the present invention relates to a (meth)acrylic composition MC1, said composition is comprising:
a) 100 parts of a liquid (meth)acrylic syrup comprising a1) between 10 wt % and 50 wt % of a (meth)acrylic polymer (P1),
a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) from 0.1 to 10 phr by weight of a (meth)acrylic monomer (M3) comprising only one (meth)acrylic function and the (meth)acrylic monomer (M3) is different from (meth)acrylic monomer (M1).

According to a second aspect, the present invention relates to a (meth)acrylic composition (MC1) comprising:
a) 100 parts of a liquid (meth)acrylic syrup comprising
   a1) between 10 wt % and 50 wt % of a (meth)acrylic polymer (P1),
   a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) between 0.1 and 10 phr by weight of a (meth)acrylic monomer (M3) comprising only one (meth)acrylic function and the (meth)acrylic monomer (M3) is different from (meth)acrylic monomer (M1); and
d)) between 0.1 phr and 5 phr of a initiator to start the polymerization of the (meth)acrylic monomers (M1), (M2) and (M3);
   e) optionally an inorganic filler C1 or fibers or a fibrous material.

According to a third aspect the present invention relates to a method for preparing a (meth)acrylic composition MC1 comprising following steps:
i) providing the following components
   a) 100 parts of a liquid (meth)acrylic syrup comprising
   a1) between 10 wt % and 50 wt % of a (meth)acrylic polymer (P1), and
      a2) between 50 wt % and 90 wt % of a (meth)acrylic monomer (M1) comprising only one (meth)acrylic function
   b) between 0.1 and 9 phr by weight a (meth)acrylic monomer (M2) comprising at least two (meth)acrylic functions
   c) between 0.1 and 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
ii) mixing the components a) to c).

According to a fourth aspect the present invention relates to use of a (meth)acrylic composition MC1 to be blended with an inorganic filler C1 or to impregnate a fibrous substrate, said (meth)acrylic composition MC1 comprises:
a) 100 parts of a liquid (meth)acrylic syrup comprising a1) between 10 wt % and 50 wt % of a (meth)acrylic polymer (P1),
   a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) from 0.1 to 10 phr by weight and preferably between 0.5 and 4 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
d) between 0.1 phr and 5 phr of a initiator to start the polymerization of the (meth)acrylic monomers (M1), (M2) and (M3).

According to a fifth aspect the present invention relates to use of a (meth)acrylic composition MC1 to prepare (meth)acrylic polymeric composition MP1, said (meth)acrylic composition MC1 comprises:
a) 100 parts of a liquid (meth)acrylic syrup comprising a1) between 10 wt % and 50 wt % of a (meth)acrylic polymer (P1),
   a2) between 50 wt % and 90 wt % of a (meth)acrylic monomer (M1) comprising only one (meth)acrylic function, and
b) between 0.01 and 9 phr by weight of a (meth)acrylic monomer (M2) comprising at least two (meth)acrylic functions;
c) between 0.1 and 10 phr by weight and preferably between 0.5 and 4 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
d) between 0.1 phr and 5 phr of a initiator to start the polymerization of the (meth)acrylic monomers (M1), (M2) and (M3).

According to a sixth aspect the present the present invention relates to a method for preparing a polymeric composite from a (meth)acrylic composition MC1, said method comprises the following steps:
i) impregnating a fibrous substrate or blending an inorganic filler C1 with a (meth)acrylic composition MC1 comprising:
   a) 100 parts of a liquid (meth)acrylic syrup comprising a1) between 10 wt % and 50 wt % of a (meth)acrylic polymer (P1),
      a2) between 50 wt % and 90 wt % of a (meth)acrylic monomer (M1) comprising only one (meth)acrylic function, and
   b) between 0.01 and 10 phr by weight of a (meth)acrylic monomer (M2) comprising at least two (meth)acrylic functions;
   c) between 0.1 and 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
   d) from 0.1 phr and 5 phr of a initiator to start the polymerization of the (meth)acrylic monomers (M1), (M2) and (M3);
ii) polymerizing the (meth)acrylic composition MC1.

According to a seventh aspect the present the present invention relates to a method for preparing a (meth)acrylic polymeric compositions from a (meth)acrylic composition MC1, said method comprises the following steps:
i) providing a (meth)acrylic composition MC1 comprising:
   a) 100 parts of a liquid (meth)acrylic syrup comprising
      a1) between 10 wt % and 50 wt % of a (meth)acrylic polymer (P1),
      a2) between 50 wt % and 90 wt % of a (meth)acrylic monomer (M1) comprising only one (meth)acrylic function, and
   b) between 0.01 and 10 phr by weight of a (meth)acrylic monomer (M2) comprising at least two (meth)acrylic functions;
   c) between 0.1 and 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
   d) from 0.1 phr and 5 phr of a initiator to start the polymerization of the (meth)acrylic monomers (M1), (M2) and (M3);
ii) polymerizing the (meth)acrylic composition MC1.

By the term “(meth)acrylic” as used is denoted any kind of acrylic and methacrylic monomers.

By the term “PMMA” as used are denoted homo- and copolymers of methylmethacrylate (MMA), for the copolymer of MMA the weight ratio of MMA inside the PMMA is at least 70 wt %.

By the term “monomer” as used is denoted is a molecule which can under go polymerization.

By the term “polymerization” as used is denoted the process of converting a monomer or a mixture of monomers into a polymer.

By the term “thermoplastic polymer” as used is denoted a polymer that turns to a liquid or becomes more liquid or less viscous when heated and that can take on new shapes by the application of heat and pressure. This applies also for slightly crosslinked thermoplastic polymers that can be thermoformed when heated above the softening temperature.

By the term “thermosetting polymer” as used is denoted a prepolymer solid or viscous state that changes irreversibly into an infusible, insoluble polymer network by curing.

By the term “prepreg” as used are denoted composition of a fibrous substrate that have been impregnated with a curable prepolymer, or liquid reactants or a thermoplastic and can be further polymerized.

By the term “prepolymer” as used is denoted a polymer or oligomer whose molecules are capable of entering, through reactive groups, into further polymerization.

By the term “oligomer” as used is denoted a polymeric molecule of intermediate relative molecular mass, comprising between 5 and 500 monomer units.

By the term “polymer composite” as used is denoted a multicomponent material comprising multiple different phase domains in which at least one type of phase domain is a continuous phase and in which at least one component is a polymer.

By the term “initiator” as used is denoted a chemical species that forms compound or an intermediate compound that starts the polymerization of a monomer, that to capable of linking successively with a large number of other monomers into a polymeric compound.

By the abbreviation “phr” is meant weight parts per hundred parts of composition. For example 1 phr of initiator in the composition means that 1 kg of initiator is added to 100 kg of composition.

By the abbreviation “ppm” is meant weight parts per million parts of composition. For example 1000 ppm of a compound in the composition means that 0.1 kg of compound is present in 100 kg of composition.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

The liquid composition a) or liquid (meth)acrylic syrup comprises a (meth)acrylic polymer (P1) and a (meth)acrylic monomer (M1).

The liquid (meth)acrylic syrup comprises between 10 wt % and 50 wt % of a (meth)acrylic polymer (P1) and between 50 wt % and 90 wt % of a (meth)acrylic monomer (M1). Preferably the liquid (meth)acrylic syrup comprises between 10 wt % and 40 wt % of a (meth)acrylic polymer (P1) and between 60 wt % and 90 wt % of a (meth)acrylic monomer (M1); and more preferably between 10 wt % and 30 wt % of a (meth)acrylic polymer (P1) and between 70 wt % and 90 wt % of a (meth)acrylic monomer (M1).

The dynamic viscosity of the liquid composition a) or liquid (meth)acrylic syrup is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20mPa*s and 1000 mPa*s. The viscosity of the syrup can be easily measured with a Rheometer or viscosimeter. The dynamic viscosity is measured at 25° C. If the liquid (meth)acrylic syrup has a Newtonian behaviour, meaning no shear thinning, the dynamic viscosity is independent of the shearing in a rheometer or the speed of the mobile in a viscometer. If the liquid composition LC1 has a non-Newtonian behaviour, meaning shear thinning, the dynamic viscosity is measured at a shear rate of 1s⁻¹ at 25° C.

As regards the liquid (meth)acrylic syrup a) that comprises the (meth)acrylic monomer (M1) and the (meth)acrylic polymer (P1), once polymerized the (meth)acrylic monomer (M1) is transformed to a (meth)acrylic polymer (P2) comprising the monomeric units of (meth)acrylic monomer (M1) and other possible monomers as (M2) and (M3). The (meth)acrylic polymeric composition (MP1) comprises (meth)acrylic polymer (P1) and (meth)acrylic polymer (P2).

As regards the (meth)acrylic polymer (P1), mention may be made of polyalkyl methacrylates or polyalkyl acrylates. By polyalkyl methacrylates or polyalkyl acrylates is meant that the polymer comprises at least 70 wt % of monomer units coming respectively from an alkyl ester of methacrylic acid or acrylic acid. According to a preferred embodiment, the (meth)acrylic polymer (P1) is polymethyl methacrylate (PMMA).

The term “PMMA” denotes a methyl methacrylate (MMA) homopolymer or copolymer or mixtures thereof.

According to one embodiment, the methyl methacrylate (MMA) homo- or copolymer comprises at least 70%, preferably at least 80%, advantageously at least 90% and more advantageously at least 95% by weight of methyl methacrylate.

According to another embodiment, the PMMA is a mixture of at least one homopolymer and at least one copolymer of MMA, or a mixture of at least two homopolymers or two copolymers of MMA with a different average molecular weight, or a mixture of at least two copolymers of MMA with a different monomer composition.

The copolymer of methyl methacrylate (MMA) comprises from 70% to 99.9% by weight of methyl methacrylate and from 0.1% to 30% by weight of at least one monomer containing at least one ethylenic unsaturation that can copolymerize with methyl methacrylate.

These monomers are well known and mention may be made especially of acrylic and methacrylic acid esters such as alkyl (meth)acrylates in which the alkyl group contains from 1 to 12 carbon atoms. As examples, mention may be made of methyl acrylate ethyl, butyl or 2-ethylhexyl (meth)acrylate. Preferably, the comonomer is an alkyl acrylate in which the alkyl group contains from 1 to 4 carbon atoms.

According to a preferred first embodiment, the copolymer of methyl methacrylate (MMA) comprises from 80% to 99.9%, advantageously from 90% to 99.9% and more advantageously from 90% to 99.9% by weight of methyl methacrylate and from 0.1% to 20%, advantageously from 0.1% to 10% and more advantageously from 0.1% to 10% by weight of at least one monomer containing at least one ethylenic unsaturation that can copolymerize with methyl methacrylate. Preferably, the comonomer is chosen from methyl acrylate and ethyl acrylate, and mixtures thereof.

The weight-average molecular mass of the (meth)acrylic polymer (P1) should be high, which means greater than 50 000 g/mol and preferably greater than 100 000 g/mol.

The weight-average molecular mass can be measured by size exclusion chromatography (SEC).

The (meth)acrylic polymer (P1) is fully soluble in the (meth)acrylic monomer (M1) or in the mixture of (meth)acrylic monomers. It enables the viscosity of the (meth)acrylic monomer (M1) or the mixture of (meth)acrylic monomers to be increased. The solution obtained is a liquid composition generally called a “syrup” or “prepolymer”. The dynamic viscosity value of the liquid (meth)acrylic syrup is between 10 mPa·s and 10 000 mPa·s. The viscosity of the syrup can be readily measured with a rheometer or a viscometer. The dynamic viscosity is measured at 25° C.

Advantageously, the liquid (meth)acrylic composition or syrup contains no additional voluntarily added solvent.

As regards the (meth)acrylic monomer (M1), the monomer is chosen from alkyl acrylic monomers, alkyl methacrylic monomers, hydroxyalkyl acrylic monomers and hydroxyalkyl methacrylic monomers, and mixtures thereof. By alkyl acrylic monomers, alkyl methacrylic monomers is meant that the monomers is an alkyl ester of methacrylic acid or acrylic acid.

Preferably, the (meth)acrylic monomer (M1) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer (M1) is chosen from methyl methacrylate, ethyl methacrylate, methyl acrylate, ethyl acrylate, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

According to a preferred embodiment, at least 50% by weight and preferably at least 608 by weight of the (meth)acrylic monomer (M1) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (M1) is a mixture of methyl methacrylate with optionally at least one other monomer.

According to a second more preferred embodiment, the monomer (M1) is methyl methacrylate.

As regards the (meth)acrylic monomer (M2), the monomer is multifunctional. The (meth)acrylic monomer (M2) comprises at least two functions that can undergo polymerization. The (meth)acrylic monomer (M2) is different from (meth)acrylic monomer (M1). The (meth)acrylic monomer (M2) is also different from (meth)acrylic monomer (M3).

The (meth)acrylic monomer (M2) can be chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10)bisphenol A diacrylate; ethoxylated (2)bisphenol A dimethacrylate; ethoxylated (3)bisphenol A diacrylate; ethoxylated (3)bisphenol A dimethacrylate; ethoxylated (4)bisphenol A diacrylate; ethoxylated (4)bisphenol A dimethacrylate; ethoxylated bisphenol A dimethacrylate; ethoxylated (10)bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy) ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly(tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate; or mixtures thereof.

Preferably the (meth)acrylic monomer (M2) is chosen from a compound comprising at least two (meth)acrylic functions. The (meth)acrylic monomer (M2) can also be chosen from a mixture of at least two compounds (M2a) and (M2b) each comprising at least two (meth)acrylic functions

In a first preferred embodiment the (meth)acrylic monomer (M2) is chosen from tricyclodecane dimethanol diacrylate or tricyclodecanedimethanol dimethacrylate.

In a second preferred embodiment the (meth)acrylic monomer (M2) is chosen from ethoxylated (10)bisphenol A diacrylate; ethoxylated (2)bisphenol A dimethacrylate; ethoxylated (3)bisphenol A diacrylate; ethoxylated (3)bisphenol A dimethacrylate; ethoxylated (4)bisphenol A diacrylate; ethoxylated (4)bisphenol A dimethacrylate; ethoxylated bisphenol A dimethacrylate; ethoxylated (10)bisphenol dimethacrylate or mixtures thereof.

The (meth)acrylic monomer (M2) can be present (meth)acrylic composition MC1 between 0.1 and 9 phr by weight, preferably is present between 0.1 and 8 phr for 100 parts of a liquid (meth)acrylic syrup, more preferably between 0.1 and 7 phr, even more preferably between 0.1 and 6 phr and advantageously between 0.1 and 5 phr.

In a first more preferred embodiment the (meth)acrylic monomer (M2) is present in (meth)acrylic composition MC1 between 0.5 and 5 phr and is chosen from a compound or a mixture of compounds comprising two (meth)acrylic functions.

In a second more preferred embodiment the (meth)acrylic monomer (M2) is present in (meth)acrylic composition MC1 between 2.5 and 5 phr and is chosen from a compound or a mixture of compounds comprising two (meth)acrylic functions.

In a third more preferred embodiment the (meth)acrylic monomer (M2) is present in (meth)acrylic composition MC1 between 0.1 and 5 phr and is chosen from a mixture of compounds comprising at least two (meth)acrylic functions.

In a fourth more preferred embodiment the (meth)acrylic monomer (M2) is present in (meth)acrylic composition MC1 between 0.1 and 5 phr and is chosen from a mixture of compounds comprising at least two (meth)acrylic functions. At least one compound of the mixture comprises only two (meth)acrylic functions and presents at least 50 wt % of the mixture of (meth)acrylic monomer (M2), preferably at least 60 wt %.

As regards the (meth)acrylic monomer (M3), the monomer is chosen from a monomer, that once polymerized as a homopolymer, it has a glass transition temperature Tg of at least 110° C., preferably at least 120° C. The glass transition temperature of homopolymers can be found in the Polymer Handbook (4th Edition): J. Brandrup, E. H. Immergut, E. A. Grulke (Eds.); Wiley, New York, 1999, Chapter VI. SOLID STATE PROPERTIES-glass transition temperatures of polymers. The glass transition temperature can also be measured, preferably by differential scanning calorimetry (DSC) according to ISO 11357-2:2020 “Plastics—Differential scanning calorimetry (DSC)—Part 2: Determination of glass transition temperature and step height”. The Polymer Handbook serves as a first indication for the glass transition temperature (in order to an order of magnitude), if there is a doubt, preferably the glass transition temperature is measured according to the previously indicated ISO 11357-2:2020.

The (meth)acrylic monomer (M3) is different from the (meth)acrylic monomers (M1) and (M2).

The (meth)acrylic monomer (M3) in a preferred embodiment is chosen from methacrylic acid, isobornyl methacrylate, tert-butyl methacrylate, phenyl methacrylate, cyclcohexyl methacrylate, 4-tert-butyl cyclohexyl methacrylate, or mixtures thereof.

The (meth)acrylic monomer (M3) in a first more preferred embodiment is chosen from methacrylic acid.

The (meth)acrylic monomer (M3) in a second more preferred embodiment is chosen from isobornyl methacrylate, tert-butyl methacrylate, phenyl methacrylate, 4-tert-butyl cyclohexyl methacrylate, or mixtures thereof.

The (meth)acrylic monomer (M3) in a third more preferred embodiment is chosen from isobornyl methacrylate, phenyl methacrylate, or mixtures thereof.

The (meth)acrylic monomer (M3) can be present in (meth)acrylic composition MC1 between 0.1 and 10 phr by weight, preferably between 0.1 and 9 phr by weight, more preferably between 0.1 and 8 phr, still more preferably between 0.1 and 7 phr, even more preferably between 0.5 and 6 phr and still even more preferably between 0.5 and 2 phr for 100 parts of a liquid (meth)acrylic syrup.

In a first most preferred embodiment the (meth)acrylic monomer (M3) is present in (meth)acrylic composition MC1 between 0.1 and 5 phr by weight for 100 parts of a liquid (meth)acrylic syrup.

In a second most preferred embodiment the (meth)acrylic monomer (M3) is present in (meth)acrylic composition MC1 between 0.1 and 4 phr by weight for 100 parts of a liquid (meth)acrylic syrup.

In a third most preferred embodiment the the (meth)acrylic monomer (M3) is present in (meth)acrylic composition MC1 between 0.1 and 2 phr by weight for 100 parts of a liquid (meth)acrylic syrup.

According to the invention, the ranges of quantities of the components a) to c) in the (meth)acrylic composition MC1 can be combined in any combination, for example preferred ranges for component b) with advantageous range of component c).

As regards the initiator to start the polymerization of the (meth)acrylic monomers (M1), (M2) and (M3), it is chosen from a radical initiator.

Preferably the radical initiator is a peroxide and more preferably the peroxide is liquid within a temperature range of between 0° C. and 50° C.

According to a particular embodiment, the polymerization initiator has a half-life temperature at 1 hour, which is greater than 70° C., advantageously greater than 80° C. and preferably greater than 90° C.

Preferably the polymerization initiator has a half-life temperature at 1 hour and 1013 mbar between 70° C. and 140° C., more preferably between 80° C. and 135° C. and still more preferably between 90° C. and 130° C. and most preferably between 95° C. and 125° C.

According to a particular embodiment, the polymerization initiator has a maximum storage temperature of at least 10° C., advantageously of at least 15° C.

The polymerization initiator may in particular comprise from 2 to 30 carbon atoms and may be chosen, for example, from, tert-amyl peroxypivalate, tert-butyl peroxypivalate, bis(3,5,5-trimethylhexanoyl) peroxide, 2,5-dimethyl-2,5-bis(2-ethylhexanoylperoxy) hexane, 1,1,3,3-tetramethylbutyl peroxy-2-ethylhexanoate, tert-amyl peroxy-2-ethylhexanoate, tert-butyl peroxy-2-ethylhexanoate, tert-butyl peroxydiethylacetate, tert-butyl peroxyisobutyrate, tert-amylperoxy-1-methoxycyclohexane, 1-1-methoxy-1-t-amylperoxy-3,3,5-methoxy-1-t-butylperoxycyclohexane, 1-methoxy-1-t-butylperoxy-3,3,5-trimethylcyclohexane, trimethylcyclohexane, 1-ethoxy-1-t-amylperoxycyclohexane, 1-ethoxy-1-t-butylperoxycyclohexan, 1-ethoxy-1-t-butyl-3,3,5-peroxycyclohexane, 1,1-di(tert-amylperoxy) cyclohexane, 1,1-di(tert-butylperoxy)-3,3,5-trimethylcyclohexane, 1,1-di(tert-butylperoxy) cyclohexane, tert-amyl peroxy-2-ethylhexylcarbonate, tert-butyl peroxy-2-ethylhexylcarbonate, tert-amyl peroxy-3,5,5-trimethylhexanoate, tert-butyl peroxy-3,5,5-trimethylhexanoate, tert-amyl peroxyacetate, tert-butyl peroxyacetate, 2,2-di(tert-butylperoxy) butane, 2,2-di(tert-amylperoxy) butane, tert-amyl peroxybenzoate, tert-butyl peroxybenzoate, butyl 4,4-di(tert-butylperoxy) valerate, 2,5-dimethyl-2,5-di(tert-butylperoxy) hexane, tert-butylcumyl peroxide, di-tert-amyl peroxide, di-tert-butyl peroxide, 1,1,3,3-tetramethylbutyl hydroperoxide, 3,5-diisopropylbenzene hydroperoxide, cumene hydroperoxide and mixtures thereof.

In an preferred variant, the polymerization initiator is chosen from tert-amyl peroxypivalate, tert-butyl peroxypivalate, bis(3,5,5-trimethylhexanoyl) peroxide, 2,5-dimethyl-2,5-bis(2-ethylhexanoylperoxy) hexane, 1,1,3,3-tetramethylbutyl peroxy-2-ethylhexanoate, tert-amyl peroxy-2-ethylhexanoate, tert-butyl peroxy-2-ethylhexanoate, tert-butyl peroxydiethylacetate, tert-butyl peroxyisobutyrate, tert-amylperoxy-1-methoxycyclohexane, 1-methoxy-1-t-butylperoxycyclohexane, 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexan, 1-ethoxy-1-t-butyl-3,3,5-peroxycyclohexane 1,1-di(tert-amylperoxy) cyclohexane, 1,1-di(tert-butylperoxy)-3,3,5-trimethylcyclohexane, 1,1-di(tert-butylperoxy) cyclohexane, tert-amyl peroxy-2-ethylhexylcarbonate, tert-butyl peroxy-2-ethylhexylcarbonate, tert-amyl peroxy-3,5,5-trimethylhexanoate, tert-butyl peroxy-3,5,5-trimethylhexanoate, tert-amyl peroxyacetate, tert-butyl peroxyacetate, 2,2-di(tert-butylperoxy) butane, 2,2-di(tert-amylperoxy) butane, tert-amyl peroxybenzoate, tert-butyl peroxybenzoate, butyl 4,4-di(tert-butylperoxy) valerate, 2,5-dimethyl-2,5-di(tert-butylperoxy) hexane mixtures thereof.

In an advantageous variant, the polymerization initiator is chosen from tert-amylperoxy-1-methoxycyclohexane, 1-methoxy-1-t-butylperoxycyclohexane, 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexan, 1-ethoxy-1-t-butyl-3,3,5-peroxycyclohexane and mixtures thereof.

On decomposing, such an initiator generates free radicals which contribute toward starting the polymerization reaction.

The amount of initiator is between 0.1 part by weight and 5 parts by weight for 100 parts of the liquid (meth)acrylic syrup, preferably between 0.1 and 4 phr, more preferably between 0.2 and 4 phr, even more preferably between 0.4 and 4 phr and advantageously between 0.5 and 4 phr for 100 parts of a liquid (meth)acrylic syrup.

The amount of initiator is meant to be calculated on the molecule that generates the radicals, in the case that the commercial compound is diluted for example.

According to the invention, the ranges of quantities of the component d) in the (meth)acrylic composition MC1 can be combined in any combination with limit or ranges or choices for components a) to c), for example preferred ranges for components a) to c).

Preferably the (meth)acrylic composition MC1 comprises no polymerization activator.

The (meth)acrylic composition MC1 can comprise other components as a coupling agent which promotes the dispersion of the mineral filler C if present in the (meth)acrylic composition MC1.

The amount of coupling agent is between 0.1 part by weight and 2 parts by weight, preferably between 0.1 part by weight and 1 parts by weight for 100 parts of the the (meth)acrylic composition MC1.

This coupling agent may be a compound comprising functional groups such as an organosilane. This coupling agent may notably be chosen from aminosilanes, vinylsilanes, methacrylsilanes and mixtures thereof. Preferably, the coupling agent is chosen from methacrylsilanes.

The (meth)acrylic composition MC1 can comprise other components as antioxidants. The antioxidant, it can be chosen from phenolic antioxidants or phosphite antioxidants. An example of phenolic antioxidants are the IRGANOX® products.

The amount of the antioxidant in the (meth)acrylic composition MC1 can be up to 10 000 ppm by weight for 100 parts of a liquid (meth)acrylic syrup.

The amount of the antioxidant is between 0 ppm by weight and 10 000 ppm by weight for 100 parts of a liquid (meth)acrylic syrup. In a specific embodiment amount of the transfer agent is preferably between 0.01 ppm by weight and 5 000 ppm by weight and more preferably between 0.1 ppm by weight and 3 000 ppm by weight for 100 parts of a liquid (meth)acrylic syrup.

The (meth)acrylic composition MC1 can comprise other components as a light stabilizer. The light stabilizer, it can for example be chosen from HALS (hindered amine light stabilizer) or phosphites.

For example the HALS can be derivates of 2,2,6,6-tetramethyl-piperidine as for example bis(2,2,6,6-tetramethyl-4-piperidyl) sebacate.

The amount of the light stabilizer in the (meth)acrylic composition MC1 can be up to 10 000 ppm by weight for 100 parts of a liquid (meth)acrylic syrup.

In a specific embodiment amount of the light stabilizer is preferably between 0.01 ppm by weight and 7 000 ppm by weight and more preferably between 0.1 ppm by weight and 5 000 ppm by weight for 100 parts of a liquid (meth)acrylic syrup.

The (meth)acrylic composition MC1 can comprise other components as thermal stabilizing agent, it can for example be chosen from a disulfide compound as for example poly-tert-amylphenol disulfide.

The amount of the thermal stabilizing agent in the (meth)acrylic composition MC1 can be up to 1 000 ppm by weight for 100 parts of a liquid (meth)acrylic syrup.

In a specific embodiment amount of the thermal stabilizing agent is preferably between 0.01 ppm by weight and 5 000 ppm by weight and more preferably between 0.1 ppm by weight and 3 000 ppm by weight relative to the sum of the (meth)acrylic monomer and of the (meth)acrylic polymer.

As regards the inorganic filler C1, mention may be made of short glass fibers, hollow glass microspheres, inorganic compounds, such as minerals and salts.

The inorganic compound is including quartz, granite, marble, feldspar, clay, ceramics, mica, graphite, silicates, carbonates, sulfates, silicates, phosphates, hydroxides, metallic oxides or combinations of two or more thereof.

As specific compound there may be cited calcium carbonate (CaCO₃), silica (SiO₂), alumina hydroxide (AlOH₃), magnesium hydroxide.

According to a particular embodiment, the filler C1 is in powder form.

The amount of the inorganic filler C1 in the (meth)acrylic composition MC1 can be up to 300 phr by weight for 100 parts of a liquid (meth)acrylic syrup.

In one specific embodiment the (meth)acrylic composition MC1 comprises between 0.01 phr by weight and 300 phr by weight, more preferably between 20 phr by weight and 300 phr and even more preferably between 30 phr by weight and 200 phr by weight of the inorganic filler C1 for 100 parts of a liquid (meth)acrylic syrup.

The quantity of the inorganic filler C1 if present, is adapted in a manner that the (meth)acrylic composition MC1 comprising it has a viscosity of 30 Pa*s or less, preferably 25 Pa*s or less at temperature of 25° C.

In one embodiment the viscosity of the (meth)acrylic composition MC1 is 20 Pa*s or less at temperature of 25° C.

In another embodiment the viscosity of the (meth)acrylic composition MC1 is 15 Pa*s or less at temperature of 25° C.

In still another embodiment the viscosity of the (meth)acrylic composition MC1 comprising an inorganic filler C1 is 0.1 Pa*s or more at temperature of 25° C.

In still another embodiment the viscosity of the (meth)acrylic composition MC1 comprising an inorganic filler C1 is 0.5 Pa*s or more at temperature of 25° C.

In a first preferred embodiment the viscosity of the (meth)acrylic composition MC1 comprising an inorganic filler C1 is between 0.1 Pa*s and 20 Pa*s at temperature of 25° C.

In a second preferred embodiment the viscosity of the (meth)acrylic composition MC1 comprising an inorganic filler C1 is between 0.5 Pa*s and 15 Pa*s at temperature of 25° C.

In a third preferred embodiment the viscosity of the (meth)acrylic composition MC1 comprising an inorganic filler C1 is between 1 Pa*s and 10 Pa*s at temperature of 25° C.

As regards the fibrous substrate, mention may be made of several fibres, uni directional rovings or continuous filament mat, fabrics, felts or nonwovens that may be in the form of strips, laps, braids, locks or pieces. The fibrous material may have various forms and dimensions, either one-dimensional, two-dimensional or three-dimensional. A fibrous substrate comprises an assembly of one or more fibres. When the fibres are continuous, their assembly forms fabrics.

The one-dimensional form corresponds to linear long fibres. The fibres may be discontinuous or continuous. The fibres may be arranged randomly or parallel to each other, in the form of a continuous filament. A fibre is defined by its aspect ratio, which is the ratio between the length and diameter of the fibre. The fibres used in the present invention are long fibres or continuous fibres. The fibres have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10 000.

The two-dimensional form corresponds to nonwoven or woven fibrous mats or reinforcements or bundles of fibres, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibres or mixtures thereof, an assembly of the two-dimensional form in the third dimension.

The origins of the fibrous material may be natural or synthetic. As natural material one can mention plant fibres, wood fibres, animal fibres or mineral fibres.

Natural fibres are, for example, sisal, jute, hemp, flax, cotton, coconut fibres, and banana fibres. Animal fibres are, for example, wool or hair.

As synthetic material, mention may be made of polymeric fibres of chosen from fibres of thermosetting polymers, thermoplastic polymers or mixtures thereof.

The polymeric fibres may consist of polyamide (aliphatic or aromatic), polyester, polyvinyl alcohol, polyolefins, polyurethanes, polyvinyl chloride, polyethylene, unsaturated polyesters, epoxy resins and vinyl esters.

The mineral fibres may also be chosen from glass fibres, especially of E, R or S2 type, carbon fibres, boron fibres or silica fibres.

The fibrous substrate of the present invention is chosen from plant fibres, wood fibres, animal fibres, mineral fibres, synthetic polymeric fibres, glass fibres and carbon fibres, and mixtures thereof.

Preferably, the fibrous substrate is chosen from mineral fibres. More preferably the fibrous substrate is chosen from glass fibres or carbon fibres.

The fibres of the fibrous substrate have a diameter between 0.005 μm and 100 μm, preferably between 1 μm and 50 μm, more preferably between 5 μm and 30 μm and advantageously between 10 μm and 25 μm.

Preferably, the fibres of the fibrous substrate of the present invention are chosen from continuous fibres (meaning that the aspect ratio does not necessarily apply as for long fibres) for the one-dimensional form, or for long or continuous fibres for the two-dimensional or three-dimensional form of the fibrous substrate.

The present invention relates also to a method for preparing a (meth)acrylic composition MC1 comprising following steps:
i) providing the following components
   a) 100 parts of a liquid (meth)acrylic syrup comprising
   a1) between 10 wt % and 50 wt % of a (meth)acrylic polymer (P1), and
   a2) between 50 wt % and 90 wt % of a (meth)acrylic monomer (M1) comprising only one (meth)acrylic function, and b) between 0.1 and 9 phr by weight of a (meth)acrylic monomer (M2) comprising at least two functions that can undergo polymerization preferably at least two (meth)acrylic functions
   c) between 0.1 and 5 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.)
ii) mixing the components a) to c).

In one specific embodiment the present invention relates to a method for preparing a (meth)acrylic composition MC1 comprising following steps:
i) providing the following components
   a) 100 parts of a liquid (meth)acrylic syrup comprising
   a1) between 10 wt % and 50 wt % of a (meth)acrylic polymer (P1), and
   a2) between 50 wt % and 90 wt % of a (meth)acrylic monomer (M1) comprising only one (meth)acrylic function, and
   b) between 0.1 and 9 phr by weight of a (meth)acrylic monomer (M2) comprising at least two functions that can undergo polymerization preferably at least two (meth)acrylic functions
   c) between 0.1 and 5 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.
   d) between 0.1 phr and 5 phr of a initiator to start the polymerization of the (meth)acrylic monomers (M1), (M2) and (M3);
ii) mixing the components a) to d)

In a further specific embodiment in step i) is also provided as compound e) an inorganic filler C1.

In further specific embodiment in step i) is also provided as compound f) a coupling agent.

The components in the method for preparing a (meth)acrylic composition MC1 and its specific embodiments are the same as defined before and their respective weight ratios.

Preferably the initiator d) is added as last component.

The present invention relates as well to the use of the (meth)acrylic composition MC1 to impregnate a fibrous substrate, said (meth)acrylic composition MC1 comprises:
a) 100 parts of a liquid (meth)acrylic syrup comprising
   a1) between 10 wt % and 50 wt % of a (meth)acrylic polymer (P1),
   a2) between 50 wt& and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) from 0.1 to 5 phr by weight of a (meth)acrylic monomer (M3) comprising only one (meth)acrylic function and the (meth)acrylic monomer (M3) is different from (meth)acrylic monomer (M1) said (meth)acrylic monomer (M3) if polymerized as a homopolymer has a glass transition temperature Tg of at least 110° C.;
d) between 0.1 phr and 5 phr of a initiator to start the polymerization of the (meth)acrylic monomers (M1), (M2) and (M3);
e) optionally an inorganic filler C1.

The present invention relates as well to the use of a (meth)acrylic composition MC1 to prepare (meth)acrylic polymeric composition (MP1), said (meth)acrylic composition MC1 comprises:
a) 100 parts of a liquid (meth)acrylic syrup comprising a1) between 10 wt % and 50 wt % of a (meth)acrylic polymer (P1),
   a2) between 50 wt % and 90 wt % of a (meth)acrylic monomer (M1) comprising only one (meth)acrylic function, and
b) between 0.1 and 9 phr by weight of a (meth)acrylic monomer (M2) comprising at least two (meth)acrylic functions;
c) between 0.1 and 5 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
d) between 0.1 phr and 5 phr of a initiator to start the polymerization of the (meth)acrylic monomers (M1), (M2) and (M3);
e) optionally an inorganic filler C1.

The components a) to e) in the use of the (meth)acrylic composition MC1 and its specific embodiments are the same as defined before and their respective weight ratios.

The present the present invention relates additionally to a method for preparing a polymeric composite from a (meth)acrylic composition MC1, said method comprises the following steps:
i) impregnating a fibrous substrate or blending an inorganic filler C1 with a (meth)acrylic composition MC1 comprising:
   a) 100 parts of a liquid (meth)acrylic syrup comprising
   a1) between 10 wt % and 50 wt % of a (meth)acrylic polymer (P1),
      a2) between 50 wt& and 90 wt % of a (meth)acrylic monomer (M1) comprising only one (meth)acrylic function, and
   b) between 0.1 and 9 phr by weight of a (meth)acrylic monomer (M2) comprising at least two (meth)acrylic functions;
   c) between 0.1 and 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.;
   d) between 0.1 phr and 5 phr of a initiator to start the polymerization of the (meth)acrylic monomers (M1), (M2) and (M3);
ii) polymerizing the (meth)acrylic composition MC1.

The components a) to d) in the method for preparing a polymeric composite are the same as defined before and their respective weight ratios. The different embodiments for the respective ranges of the rations can be combined in any variation concerning the preferred or more preferred or other embodiments.

The polymerization step takes place at a temperature typically below 110° C., preferably below 105° C. and more preferably below 100° C.

The polymerization step takes place at a temperature typically between 80° C. and 110° C., preferably between 90° C. and 105° C. and more preferably between 90° C. and 100° C.

In a particular embodiment, the polymerization step takes place at a temperature between 95° C. and 100° C.

The polymerization takes place in a mould, and preferably in a closed mold.

Once polymerized the (meth)acrylic composition MC1 has been polymerized, the three components a2) (meth)acrylic monomer (M1), b) the (meth)acrylic monomer (M2) comprising at least two (meth)acrylic functions and c) (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.; are all together part of a polymer (P2).

In the more preferred case that the (meth)acrylic monomer (M3) is (meth)acylic acid the (meth)acrylic polymer (P2) formed could also comprise anhydride units.

After the copolymerization of the methacrylic acid as (M3) with (M1) and (M2) for forming the main chain of the (meth)acrylic polymer (P2), the carboxylic acid group could react further. Either the carboxylic acid group of the copolymerized methacrylic acid is still present as lateral group in the polymer chain or for example two carboxylic acid groups could have formed an anhydride, for example a type of glutaric anhydride.

In one embodiment, at least 5% of the polymerized methacrylic acid units are transformed to anhydrides.

In another embodiment, at least 20% of the polymerized methacrylic acid units are transformed to anhydrides.

In still another embodiment, at least 0.5% of the polymerized methacrylic acid units are transformed to anhydrides.

Preferably between 0% and 50% of the polymerized methacrylic acid units in the (meth)acrylic polymer (P2) are transformed to anhydrides.

With regard to the use of polymeric composite material, one can mention automotive and motorsports applications as for example pressure vessel, ballistic & defense applications, marine applications, railroad and transport applications, sport, leisure and recreational applications, arts and entertainments applications, aeronautic and aerospace applications, construction and civil engineering applications, housing applications, oil & gas applications, renewable applications such as photovoltaic applications and wind energy applications.

As regards the use of the mechanical parts made of composite material thus manufactured, mention may be made of automotive applications, transport applications such as buses or lorries, marine applications, railroad applications, sport, aeronautic and aerospace applications, photovoltaic applications, computer-related applications, construction and building applications, packaging or storage application, telecommunication applications and wind energy applications.

The mechanical part made of composite material is especially a motor vehicle part, boat part, bus part, train part, sport article, plane or helicopter part, space ship or rocket part, photovoltaic module part, a material for construction or building, wind turbine part for example spar cap of girder of wind turbine blade, furniture part, bathroom and/or kitchen equipment, construction or building part.

### BRIEF DESCRIPTION OF THE DRAWINGS

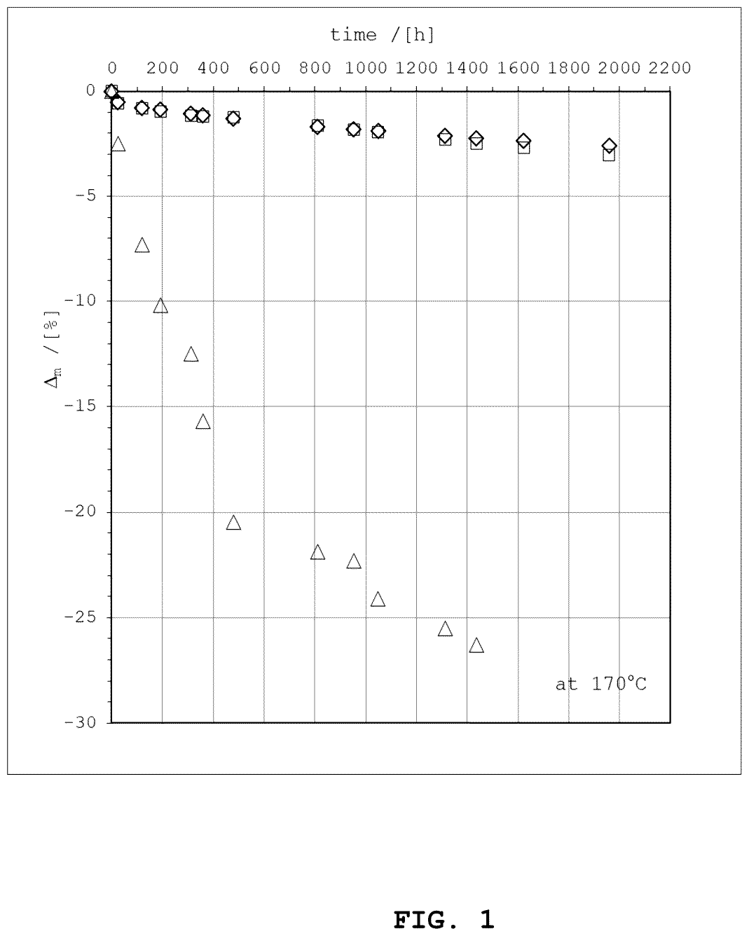

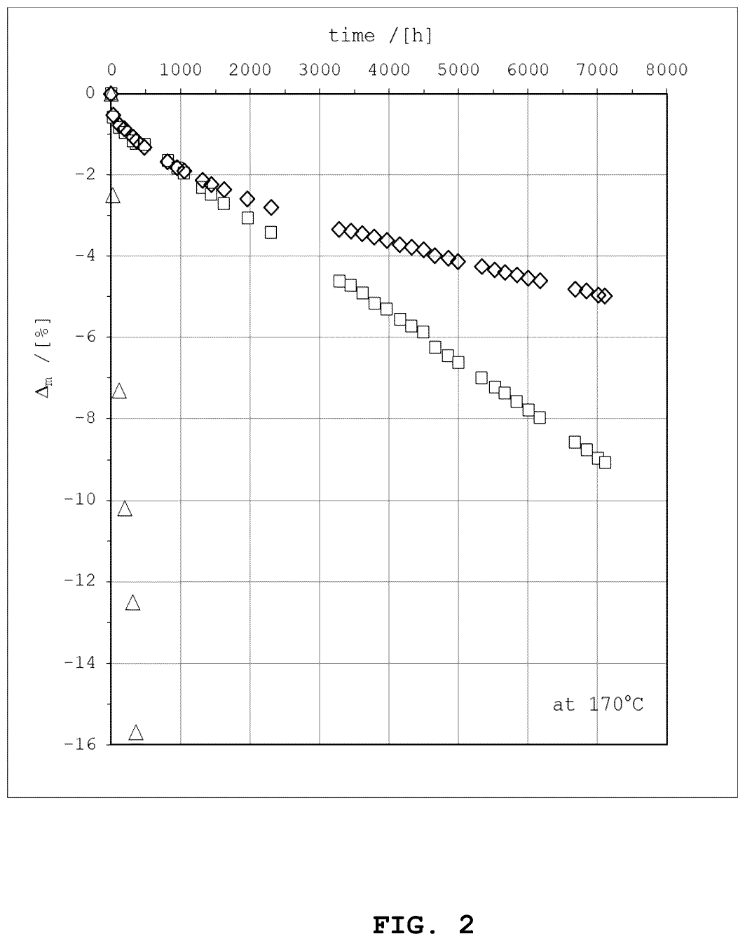

FIGURES: FIGS. 1 and 2 shows the relative loss of mass of samples (Δₘ in %) as function of time at 170° C. The triangle (Δ) symbol is a comparative example and diamond and square (⋄ and □) symbols are examples according to the invention made from syrups S2 and S3 respectively.

### [Methods]

The viscosity is measured at a shear rate of 1s⁻¹ at 25° C. with a rheometer.

The glass transition temperature Tg is measured with dynamic differential calorimetry (differential scanning calorimetry, DSC) using a TA Q2000 apparatus, according to ISO 11357-2/2013 at a heating rate of 20 K/min.

The molecular weight is measured by size exclusion chromatography (SEC). The chromatography column is calibrated with PMMA standards having a molecular weight between 402 g/mol and 1 900 000 g/mol. The average molecular weight are expressed in g/mol for the number and weight average molecular weight Mn and Mw respectively. For the measurement the concentration is 1 g/L.

### EXAMPLES

A liquid (meth)acrylic syrup S0 is prepared by dissolving 20 parts by weight of the PMMA (BS520 a copolymer of MMA comprising ethyl acrylate as a comonomer from Altuglas) as (P1) in 80 parts by weight of methyl methacrylate as (M1), which is stabilized with MEHQ (hydroquinone monomethyl ether). Liquid (meth)acrylic Syrup S0 is used to prepare the composition of comparative examples and the examples of the invention by adding additional compounds.

Comparative example 1: A syrup S1 is prepared from 100 parts by weight of syrup so by adding 1 part by weight of 1,4-butanediol dimethacrylate (SR214 from Sartomer), 1 part by weight of triethyleneglycol dimethacrylate (SR205 from Sartomer), 0.3 parts by weight of coupling agent Geniosil® GF31 (from Wacker). Later 2 parts by weight of are added 2,5-dimethyl-2,5-di(2-ethylhexanoylperoxy) hexane (TRIGONOX® 141 from AKZO NOBEL) are added.

Example 1: A syrup S2 is prepared from syrup SO by adding to the 100 parts by weight of the syrup SO the following additional compounds: 4 parts by weight of ethoxylated bisphenol A dimethacrylate as (M2) (SR348 from Sartomer), 1 part by weight of methacrylic acid as (M3), 0.3 parts by weight of coupling agent Geniosil® GF31 (from Wacker), 0.1 parts by weight of bis(2,2,6,6-tetramethyl-4-piperidyl) sebacate (Tinuvin® 770DF from BASF), 0.1 parts by weight 3,5-bis(1,1-dimethylethyl)-4-hydroxy-, 1,1′-(thiodi-2,1-ethanediyl) ester (IRGANOXR 1035 from BASF), 0.1 parts Vultac3. Later 2 parts by weight of tert-amyl peroxy-1-methoxycycclohexane are added.

Example 2: A syrup S3 is prepared from syrup S0 by adding to 100 parts by weight of the syrup 5 parts 1,4-butanediol dimethacrylate (SR214 from Sartomer), 5 part by weight of methacrylic acid as (M3), 0.3 parts by weight of coupling agent Geniosil® GF31 (from Wacker), 0.1 parts by weight of bis(2,2,6,6-tetramethyl-4-piperidyl) sebacate (Tinuvin® 770DF from BASE), 0.1 parts by weight of 3,5-bis(1,1-dimethylethyl)-4-hydroxy-, 1,1′-(thiodi-2,1-ethanediyl) ester (IRGANOX® 1035 from BASF), 0.1 parts Vultac3. Later 2 parts by weight of tert-amyl peroxy-1-methoxycycclohexane are added.

Each of the respective syrups S1 to S3 is blended with 61 wt % of silica, the two together making up 100 wt %. At the end, the 2 parts by weight of each respective initiator relative to the syrup part are added. The compositions are mixed in order to obtain a homogenous composition. The respective compositions are put under vacuum for degassing and transferred into a mold. Mold is heated so that the temperature is 96° C.

Three molded materials are obtained based on the respective syrups S1, S2 and S3.

The thermal aging is evaluated on each of the three molded compounds. Therefor a sample of about 20 g is cut off from each molded compounds. The samples are put in a ventilated oven at 170° C. and the samples are weighted from time to time over a period of about several hundred hours.

The thermal aging is expressed in a relative mass loss Δₘ in % from the mass of the initial sample.

This relative mass loss is shown in FIGS. 1 and 2 for the material obtained from the polymerization of the three respective syrups. FIGS. 1 and 2 shows that the relative mass loss for example 1 (⋄) and example 2 (□) according to the invention are less than the comparative example (Δ), which signifies a better thermal resistance.

1. A (meth)acrylic composition MC1 comprising,
a) 100 parts of a liquid (meth)acrylic syrup comprising
a1) between 10 wt % and 50 wt % of a (meth)acrylic polymer (P1), and
a2) between 50 wt % and 90 wt % of a (meth)acrylic monomer (M1) comprising only one (meth)acrylic function; and
b) between 0.1 and 9 phr by weight of a (meth)acrylic monomer (M2) comprising at least two functions that can undergo polymerization, preferably at least two (meth)acrylic functions;
c) between 0.1 and 10 phr by weight of a (meth)acrylic monomer (M3) comprising only one (meth)acrylic function and the (meth)acrylic monomer (M3) is different from (meth)acrylic monomer (M1), said (meth)acrylic monomer (M3) if polymerized as a homopolymer has a glass transition temperature Tg of at least 110° C.; and
e) optionally an inorganic filler C1 or fibers or a fibrous material.

2. The (meth)acrylic composition MC1 according to claim 1, wherein the composition comprises additionally
d) between 0.1 phr and 5 phr of an initiator to start the polymerization of the (meth)acrylic monomers (M1), (M2) and (M3).

3. The (meth)acrylic composition MC1 according to claim 1, wherein the composition comprises additionally
e) an inorganic filler C1 or fibers or a fibrous material.

4. The (meth)acrylic composition MC1 according to claim 1, wherein the (meth)acrylic monomer (M3) is chosen from methacrylic acid, isobornyl methacrylate, tert-butyl methacrylate, phenyl methacrylate, cyclcohexyl methacrylate, 4-tert-butyl cyclohexyl methacrylate, or mixtures thereof.

5. The (meth)acrylic composition MC1 according to claim 1, wherein the (meth)acrylic monomer (M3) is chosen from methacrylic acid.

6. The (meth)acrylic composition MC1 according to claim 1, wherein the (meth)acrylic monomer (M2) is chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10)bisphenol A diacrylate; ethoxylated (2)bisphenol A dimethacrylate; ethoxylated (3)bisphenol A diacrylate; ethoxylated (3)bisphenol A dimethacrylate; ethoxylated (4)bisphenol A diacrylate; ethoxylated (4)bisphenol A dimethacrylate; ethoxylated bisphenol A dimethacrylate; ethoxylated (10)bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy) ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly(tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate; or mixtures thereof.

7. The (meth)acrylic composition MC1 according to claim 1, wherein the (meth)acrylic monomer (M2) is chosen from tricyclodecane dimethanol diacrylate or tricyclodecanedimethanol dimethacrylate.

8. The (meth)acrylic composition MC1 according to claim 1, wherein the (meth)acrylic monomer (M2) is chosen from ethoxylated (10)bisphenol A diacrylate; ethoxylated (2)bisphenol A dimethacrylate; ethoxylated (3)bisphenol A diacrylate; ethoxylated (3)bisphenol A dimethacrylate; ethoxylated (4)bisphenol A diacrylate; ethoxylated (4)bisphenol A dimethacrylate; ethoxylated bisphenol A dimethacrylate; ethoxylated (10)bisphenol dimethacrylate or mixtures thereof.

9. The (meth)acrylic composition MC1 according to claim 1, wherein the (meth)acrylic monomer (M1) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

10. The (meth)acrylic composition MC1 according to claim 2, wherein the initiator d) is in the form of a peroxide compound that is liquid within a temperature range of between 0° C. and 50° C.

11. The (meth)acrylic composition MC1 according to claim 2, wherein the initiator d) has a half-life temperature at 1 hour, which is greater than 70° C.

12. The (meth)acrylic composition MC1 according to claim 2, wherein the initiator d) has a half-life temperature at 1 hour and 1013 mbar between 70° C. and 140° C., more preferably between 80° C. and 135° C. and still more preferably between 90° C. and 130° C. and most preferably between 95° C. and 125° C.

13. The (meth)acrylic composition MC1 according to claim 2, wherein the initiator d) is chosen from tert-amyl peroxypivalate, tert-butyl peroxypivalate, bis(3,5,5-trimethylhexanoyl) peroxide, 2,5-dimethyl-2,5-bis(2-ethylhexanoylperoxy) hexane, 1,1,3,3-tetramethylbutyl peroxy-2-ethylhexanoate, tert-amyl peroxy-2-ethylhexanoate, tert-butyl peroxy-2-ethylhexanoate, tert-butyl peroxydiethylacetate, tert-butyl peroxyisobutyrate, tert-amylperoxy-1-methoxycyclohexane, 1-methoxy-1-t-butylperoxycyclohexane, 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexan, 1-ethoxy-1-t-butyl-3,3,5-peroxycyclohexane 1,1-di(tert-amylperoxy) cyclohexane, 1,1-di(tert-butylperoxy)-3,3,5-trimethylcyclohexane, 1,1-di(tert-butylperoxy) cyclohexane, tert-amyl peroxy-2-ethylhexylcarbonate, tert-butyl peroxy-2-ethylhexylcarbonate, tert-amyl peroxy-3,5,5-trimethylhexanoate, tert-butyl peroxy-3,5,5-trimethylhexanoate, tert-amyl peroxyacetate, tert-butyl peroxyacetate, 2,2-di(tert-butylperoxy) butane, 2,2-di(tert-amylperoxy) butane, tert-amyl peroxybenzoate, tert-butyl peroxybenzoate, butyl 4,4-di(tert-butylperoxy) valerate, 2,5-dimethyl-2,5-di(tert-butylperoxy) hexane mixtures thereof.

14. The (meth)acrylic composition MC1 according to claim 2, wherein the initiator d) is chosen tert-amylperoxy-1-methoxycyclohexane, 1-methoxy-1-t-butylperoxycyclohexane, 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexan, 1-ethoxy-1-t-butyl-3,3,5-peroxycyclohexane and mixtures thereof.

15. The (meth)acrylic composition MC1 according to claim 1, wherein the (meth)acrylic composition MC1 comprises no polymerization activator.

16. The (meth)acrylic composition MC1 according to claim 1, wherein the (meth)acrylic composition MC1 comprises between 0.1 and 5 phr by weight of the (meth)acrylic monomer (M3).

17. The (meth)acrylic composition MC1 according to claim 1, wherein the liquid (meth)acrylic syrup comprises:
a1) between 10 wt % and 30 wt % of a (meth)acrylic polymer (P1), and
a2) between 70 wt % and 90 wt % of a (meth)acrylic monomer (M1) comprising only one (meth)acrylic function.

18. The (meth)acrylic composition MC1 according to claim 1, wherein the (meth)acrylic monomer (M2) is present between 0.1 and 8 phr for 100 parts of a liquid (meth)acrylic syrup, more preferably between 0.1 and 7 phr, even more preferably between 0.1 and 6 phr and advantageously between 0.1 and 5 phr.

19. The (meth)acrylic composition MC1 according to claim 1, wherein the (meth)acrylic monomer (M2) is present between 0.5 and 5 phr for 100 parts of a liquid (meth)acrylic syrup.

20. The (meth)acrylic composition MC1 according to claim 1, wherein the (meth)acrylic monomer (M2) is present between 2.5 and 5 phr for 100 parts of a liquid (meth)acrylic syrup.

21. The (meth)acrylic composition MC1 according to claim 1, wherein the (meth)acrylic monomer (M2) is present between 0.1 and 5 phr and is chosen from a mixture of compounds comprising at least two (meth)acrylic functions, for 100 parts of a liquid (meth)acrylic syrup.

22. The (meth)acrylic composition MC1 according to claim 1, wherein the (meth)acrylic composition MC1 comprises between 0.1 and 4 phr by weight of the (meth)acrylic monomer (M3).

23. The (meth)acrylic composition MC1 according to claim 1, wherein the (meth)acrylic composition MC1 comprises between 0.1 and 2 phr by weight of the (meth)acrylic monomer (M3).

24. The (meth)acrylic composition MC1 according to claim 3, wherein the composition comprises an inorganic filler C1.

25. The (meth)acrylic composition MC1 according to claim 3, wherein the composition comprises between 0.01 phr by weight and 300 phr by weight of an inorganic filler C1 for 100 parts of a liquid (meth)acrylic syrup.

26. The (meth)acrylic composition MC1 according to claim 24, wherein the viscosity of the (meth)acrylic composition MC1 comprising an inorganic filler C1 is between 0.1 Pa*s and 20 Pa*s at 25° C.

27. The (meth)acrylic composition MC1 according to claim 3, wherein the composition comprises fibers.

28. The (meth)acrylic composition MC1 according to claim 3, wherein the composition comprises a fibrous substrate.

29. Method for preparing a (meth)acrylic composition MC1 according to claim 1, wherein said method comprises the following steps:
i) providing the following components:
a) a (meth)acrylic polymer (P1) and a (meth)acrylic monomer (M1) comprising only one (meth)acrylic function;
b) a (meth)acrylic monomer (M2) comprising at least two (meth)acrylic functions;
c) a (meth)acrylic monomer (M3) comprising only one (meth)acrylic function and the (meth)acrylic monomer (M3) is different from (meth)acrylic monomer (M1);
d) optionally an initiator to start the polymerization of the (meth)acrylic monomers (M1), (M2) and (M3); and
e) optionally an inorganic filler C1 or fibers or a fibrous material; and
ii) mixing the components a) to c) or a) to d) or a) to e) in their respective ratios.

30. (canceled)

31. (canceled)

32. A method for preparing a polymeric composite from a (meth)acrylic composition MC1 according to claim 1, wherein said method comprises the following steps:
i) impregnating a fibrous substrate or blending an inorganic filler C1 with said (meth)acrylic composition MC1; and
ii) polymerizing the (meth)acrylic composition MC1.

33. The method for preparing a polymeric composite according to claim 32, wherein the polymerization step takes place at a temperature between 80° C. and 110° C.

34. The method for preparing a polymeric composite according to claim 32, wherein the polymerization takes place in a mould, and preferably in a closed mold.

35. A polymeric composite material obtained from a method according to claim 32.

36. Use of the composite material of claim 35 in automotive and motorsports applications as for example pressure vessel, ballistic & defense applications, marine applications, railroad and transport applications, sport, leisure and recreational applications, arts and entertainments applications, aeronautic and aerospace applications, construction and civil engineering applications, oil & gas applications, renewable applications such as photovoltaic applications and wind energy applications.
